(19) United States
(12) Patent Application Publication
(10) Pub. No.: US 2026/0230774 A1
(43) Pub. Date: Aug. 6, 2026

(54) MOBILE FEATURE DETECTOR AND SYSTEMS AND METHODS FOR MANAGING THE SAME

(71) Applicant: Toyota Jidosha Kabushiki Kaisha, Toyota-shi Aichi-ken (JP)

(72) Inventor: Alexander Granieri, Mountain View, CA (US)

(73) Assignee: Toyota Jidosha Kabushiki Kaisha, Toyota-shi Aichi-ken (JP)

(21) Appl. No.: 19/042,859

(22) Filed: Jan. 31, 2025

(51) Int. Cl. H04W 4/021

(52) U.S. Cl. CPC H04W 4/021

(57) ABSTRACT

A system, method, and participating vehicle for identifying features and/or points of interest relevant to an occupant of a vehicle in an environment of said vehicle are disclosed. The system includes one or more sensors for sensing the environment, a user profile for defining occupant preferences, and a computational model for identifying features relating to the preferences within the sensor data collected by the sensors. The system may store the detected features for later perusal by the occupant, and/or the system may notify the occupant that a certain feature was detected through visual, auditory, or haptic means. The system may further supplement the features so identified by querying databases external to the vehicle.

### TECHNICAL FIELD

Embodiments described herein generally relate to mobile systems for independently and automatically detecting points of interest which relate to a set of user preferences.

### BACKGROUND

When piloting a vehicle, most peoples’ attention is typically consumed by the demands of the road, waterway, or relevant path of travel. Drivers are trained to focus on essential tasks such as monitoring traffic, adhering to road signs, and anticipating potential hazards. This heightened focus on driving-related cues is a critical safety measure, but it often means that much of the surrounding scenery goes unnoticed. Whether it’s a vibrant cityscape, a stretch of countryside, or fleeting moments of natural beauty, the act of driving naturally limits our ability to take in and appreciate the environment around us.

Though less limited in this regard, passengers, too, are not immune to missing scenery or passing points of interest. With the rise of smartphones, portable devices, and other forms of in-car entertainment, passengers often find themselves distracted by screens, engrossed in conversation, or focused on other happenings. Even those who glance out the window may be more focused on destinations, navigation, or the practical aspects of the journey rather than fully absorbing the environment around them.

As a result, opportunities to appreciate interesting elements of these environments and surroundings can be easily overlooked by all occupants of a vehicle. These elements, or points of interest, can vary from natural scenes and/or particular plants, to certain buildings and/or styles of architecture, to food trucks and/or pop-up stands, to art installations, announcement signs, and more. Missing these points of interest may lead to missed opportunities, or the fear of missing out may encourage some to neglect more critical tasks due to “rubbernecking.” In either case, a solution is needed that can catalogue these points of interest in a way that may remove the stressors of time from experiencing them.

By leveraging the sensor packages that are, with increasing regularity, being included on vehicles of all kind – from smart cars to drones and even watercraft – a system for monitoring the environment of a vehicle, identifying these points of interest, and logging them for later perusal by the occupants of the vehicle may be implemented to solve this problem.

### SUMMARY

In one embodiment, a system for detecting points of interest that includes a vehicle having at least one sensor which is configured to measure, observe, scan, or otherwise evaluate an environment of the vehicle, a computational model executed by one or more processors, computers or the like provided on the vehicle to perform feature recognition on the sensor data obtained by these sensors, and a user profile which is configured to store preferences of an occupant of the vehicle which relate to features, objects, or the like which are detectable by the computer model that the user has expressed or otherwise defined an interest in. The system may further include a notifier unit for conveying such a notification to the occupant and/or a storage unit for retaining these detections for later perusal by the occupant.

In another embodiment, a method for detecting points of interest that includes providing a vehicle with at least one processor, computer, or the like and with at least one sensor, measuring, observing, scanning, or otherwise evaluating the environment using the at least one sensor to generate sensor data, processing the data using a computational model executed by the processors/computers of the vehicle to perform feature recognition, and identifying one or more features within the data that relate to one or more preferences of an occupant of the vehicle as stored in a user profile. The method may further include notifying the occupant of the detection and/or storing the detection for later perusal by the occupant.

In another embodiment, a vehicle which is capable of detecting points of interest in its environment, the vehicle including one or more processors, computers, or the like, at least one sensor, a computational model, and a user profile, such that the profile stores at least one preference of at least one occupant of the vehicle that is identifiable by the computational model within sensor data collected by the at least one sensor.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a block diagram depicting an exemplary system for detecting points of interest around a vehicle according to one or more embodiments described and/or illustrated herein;

FIG. 2 schematically depicts an exemplary detection scenario according to one or more embodiments described and/or illustrated herein;

FIG. 3A shows in greater detail exemplary features which may be detected according to one or more embodiments described and/or illustrated herein;

FIG. 3B shows in greater detail exemplary features which may be detected according to one or more embodiments described and/or illustrated herein;

FIG. 4 schematically depicts an exemplary user profile according to one or more embodiments described and/or illustrated herein; and

FIG. 5 depicts a process chart for an exemplary method according to one or more embodiments described and/or illustrated herein.

### DETAILED DESCRIPTION

Embodiments of the disclosure described and illustrated herein provide for a mobile point of interest detection system which leverages sensor packages provided on vehicles to, in real-time, measure, scan, evaluate, and/or otherwise observe an environment around the vehicle to generate sensor data, perform feature recognition on said sensor data, and identify any features which correspond to, relate to, or are otherwise relevant to user preferences of one or more occupants of the vehicle within a user profile.

This overall scheme is achieved, in part, by using one or more sensors provided on-board a vehicle to generate sensor data and executing a computational model provided on said vehicle to perform feature recognition on the sensor data. While it is contemplated that such vehicles may be provided with network interfaces through which third-party or otherwise external databases may be searched or queried for points of interests in the vicinity of the vehicle based on, e.g., global positioning system (GPS) readings and the like, it is preferable that the computational model be capable of identifying features and/or points of interest independent of such queries. This independence leads to a number of benefits, including the detection of features and/or points of interests which may not be registered or stored within those databases or which might not be searchable for based on the preferences of the user. This independence may also permit the system to function when access to those databases, sources, cloud-based models/resources, and the like are otherwise unavailable, such as due to an outage, due to a lack of cellular service signal, and so on.

However, it is also contemplated that, once a feature and/or point of interest has been identified by the computational model, this identification may serve as the basis for a query to an external database or the like for supplementary information. For example, upon detecting a type of tree that an occupant is particularly fond of, the vehicle may search for any significance of the tree which was detected and/or any further information relating to trees of that type in the immediate area which may be outside of the detection range or the like of the vehicle’s sensors. As another example, detection of a food truck may prompt a query for the name of the food truck company, menus, schedules or the like. The model may be configured to formulate such a query, or a second model, such as a large language model, may be employed to generate such prompts.

The term “occupant,” as used herein, may refer to any of drivers, passengers, persons (such as fleet managers, coordinators, dispatchers, and the like), and/or autonomous vehicle control stacks which are associated with a given vehicle. Except where explicitly indicated otherwise, “occupant” is not to be limited with respect to whether said person is currently occupying a vehicle (e.g., a passenger who exits a vehicle to go see a movie is still considered an occupant of the vehicle while they are sitting in the theater and the vehicle is parked outside). In situations concerning fleet vehicles, autonomous vehicles, or similar, “occupant” may simultaneously refer to both a driver of a vehicle and a dispatcher. In other scenarios, “occupant” may simultaneously refer to both a passenger and an autonomous vehicle control stack. In other words, messages, responses, messaging, notifications, and the like may be sent to/from/between all entities embodying “occupant” as may be relevant to the presented scenario.

The term “vehicle,” as used herein, may refer to any car, truck, motorcycle, van, scooter, or the like, without limit, used in the course of personal, recreational, or commercial transportation. Aerial, aquatic, off-road, and/or industrial vehicles are also contemplated. The vehicle may be manually driven by an occupant, semi-autonomously driven, or fully autonomous, at any level of automation, such as that defined by the Society of Automotive Engineers (SAE) J31016 standard levels 0 through 5.

It may further be appreciated that different sensors and/or sensing means have different affinities for verbs which describe the manner in which these sensors collect data. For example, it may be more suitable to say that a LiDAR scanner “scans” or “maps” an environment, whereas it may be more suitable to say that a photo camera “images” an environment. Given the largely sensor-agnostic approach taken for many of the embodiments discussed herein, different usages of words like scan, measure, evaluate, observe, map, image, etc. are not intended to create or draw distinctions between the sensing means so employed, except where explicitly indicated otherwise.

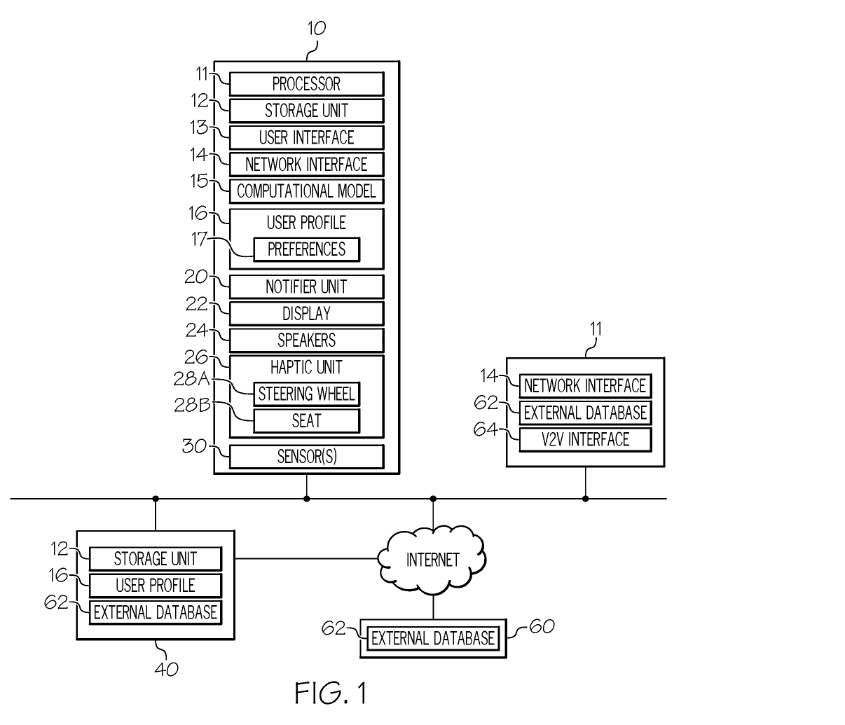

Turning now to FIG. 1, a system diagram for an example system according to the disclosure herein is shown. The system may include one or more vehicles 10, a secondary vehicle 11, a mobile device 40 – such as a mobile phone, feature phone, smartphone, tablet, PDA. smartwatch or other smart-jewelry/accessory device, or the like, without limitation – of an occupant of the vehicle, and an external server 60. It should be noted that secondary vehicle 11 may include any of those components of vehicle 10, and vice versa; secondary vehicle 11 is shown differently from vehicle 10 for illustrative purposes only.

Vehicle 10 may include one or more processors 11, storage units 12, memory units, non-transitory computer-readable storage mediums, and the like – including general purpose computers, field-programmable gate arrays, application-specific integrated circuits, and so on, without limitation – which are capable of storing data and/or code for executing processes/functions/operations, such as the computational model 15 and any processes, functions, and/or operations in support thereof. The vehicle 10 may be provided with one or more user interfaces 13, such as a head unit, infotainment system, any number of buttons, dials, levers, and the like, voice command/control interfaces, and so on, for interacting with the systems of the vehicle 10. User interfaces 13 may include or be separate from one or more displays 22 – such as display screens, LCD/LED screens, indicator lights, and the like, without limitation – and/or speakers 24 – such as audio speakers, headphones, auxiliary audio out ports, Bluetooth-connected audio devices, and the like, without limitation.

Vehicle 10 may be provided with one or more sensors 30 for detecting the environment around the vehicle. Sensors 30 may include cameras or visual light sensors, infrared/ultraviolet cameras/sensors, radar emitters/detectors, ultrasonic emitters/detectors, LiDAR scanners, microwave emitters/detectors, time-of-flight scanners/detectors, and any other similar or comparable scanner or detector which is capable of taking measurements, images, scans, mappings, and the like of an environment at a distance and, in turn, generate sensor data corresponding to the same. The one or more sensors 30 may also include devices such as GPS sensors or sensors of other satellite-position-based or other general position-based technologies, clocks/timers, microphones, and the like, as well as any supporting systems/detectors/emitters necessary to facilitate operation of the vehicle 10 and/or sensors 30.

Computational model 15 may be embodied as a model that is executable by the one or more processors 11 of the vehicle 11 and that is configured to perform feature recognition on the sensor data captured by the one or more sensors 30. Computational model 15 may be a traditionally-programmed algorithm and/or rule based model, a statistical model, optimization model, neural network, reinforcement learning model, machine-learning model, agent-based model, ensemble model, and the like, without limitation. Computational model 15 may be a smaller model which is distilled from a larger model, such as through model compression, knowledge distillation, edge deployment, and the like, such that the computational model 15 may achieve results similar to that of the larger model while also being capable of running on resource-constrained devices.

The computational model 15 may further be supplied with mapping data, HD mapping data (e.g., LIDAR point clouds of the environment as captured by one or more vehicles), positional data, or the like to assist in feature detection and/or recognition.

A user profile 16, which contains one or more occupant preferences 17 for objects, features, and the like in which an occupant is interested, may be stored on the vehicle 10, on the mobile device 40, or even on the external server 60. The user profile 16 and/or preferences 17 are used by the computational model to conduct feature recognition and/or to identify which features to search for within the sensor data collected by the one or more sensors 30. Preferences 17 may be populated by surveying the occupant with specific questions, may be derived from natural language descriptions of the occupant’s interests, may be determined from search/purchase histories and/or preferences recorded on other services, or may arise from any other suitable way of recording what items interest the occupant. Preferences may relate to items including, but not limited to, certain types of architecture, vehicle models, restaurant types, geological features, parks, types of plants, types of animals, and so on.

Each vehicle 10 may also be provided with one or more network interfaces 14, such as cellular data interfaces (e.g., 3G, 4G, 5G, LTE, GSM, without limitation), satellite uplinks and/or modems, WiFi, Bluetooth, ZigBee, Z-wave, RFID, and the like by which the vehicle may communicate, directly or indirectly, with the internet, an occupant’s mobile device 40, an external server 60 and/or edge computing device, and the like.

Vehicle 10 may further include a notifier unit 20, which is provided to convey notifications to the occupant and may be embodied as any of the user interfaces 13, displays 22, or speakers 24 described above, and/or may include a haptic unit 26. Notifications may include push notifications, text messages, emails, sounds, alerts, recorded and/or real-time synthesized voice/audio messages, light indicators (blinking, modulated, or otherwise), vibrations/buzzing, nudging, and so on, without limitation.

Haptic unit 26 may be a device which is capable of providing mechanical feedback to an occupant of the vehicle 10, such as by shaking/vibrating a steering wheel 28a, seat 28b, or other element of the vehicle 10 to provide a mechanical or tactile stimulus to the occupant. Haptic unit 26 may therefore include any number of motors, actuators, servos, pistons, pneumatics, hydraulics, control circuits, and the like, without limitation, for generating the tactile stimulus.

Secondary vehicle 11, as noted above, may include any of those components of vehicle 10, and vice versa. Vehicle 10 and secondary vehicle 11 may each include vehicle-to-vehicle (V2V) interfaces 64, as part of or separate from network interfaces 14, for communication with nearby vehicles and/or each other. Additionally, one or more storage units 12 of the secondary vehicle 11 may serve as or alongside an external database 62 or external server provided on the secondary vehicle 11, the term “external” here meaning from the perspective of vehicle 10.

The V2V interfaces 64 may be used to exchange information between the vehicle 10 and secondary vehicle 11 regarding detected features (e.g., if a road hazard was detected), shared interests (e.g., if occupants of both vehicles are looking for restaurants with outdoor seating, secondary vehicle 11 may communicate to vehicle 10 that one such restaurant was recently passed), queries (e.g., did the secondary vehicle 11 observe the hours of operation of said restaurant, or was the secondary vehicle 11 able to download the restaurant’s menu), and the like.

Mobile device 40 likewise includes any number of processors, storage units 12, memory units, software, and user interfaces to carry out those operative functions and interactions of the mobile device 40. Likewise, said storage units 12 of the mobile device 40 may serve as or alongside an external database 62 or external server provided on the mobile device 40, the term “external” here meaning from the perspective of vehicle 10. The user profile 16 may also or alternatively be stored on the mobile device 40 hardware. For example, the vehicle 10 may query the mobile device 40 for information relating to detected points of interest or features. Additionally/alternatively, the vehicle 10 may conduct external server 60 queries by way of the mobile device 40.

The system may further include an external server 60 or database which may be in operative communication with any of the vehicle 10, secondary vehicle 11, and mobile device 40 through the internet or similar network. Server 60 may, likewise, include an external database 62, the term “external” here meaning from the perspective of vehicle 10. Additionally/alternatively, the external server 60 may be an edge device or roadside device which performs similar functions but which may be connected to/communicated through protocols such as vehicle-to-everything (V2X) or the like. It is also contemplated that the user profile 16 may be stored on the external server 60.

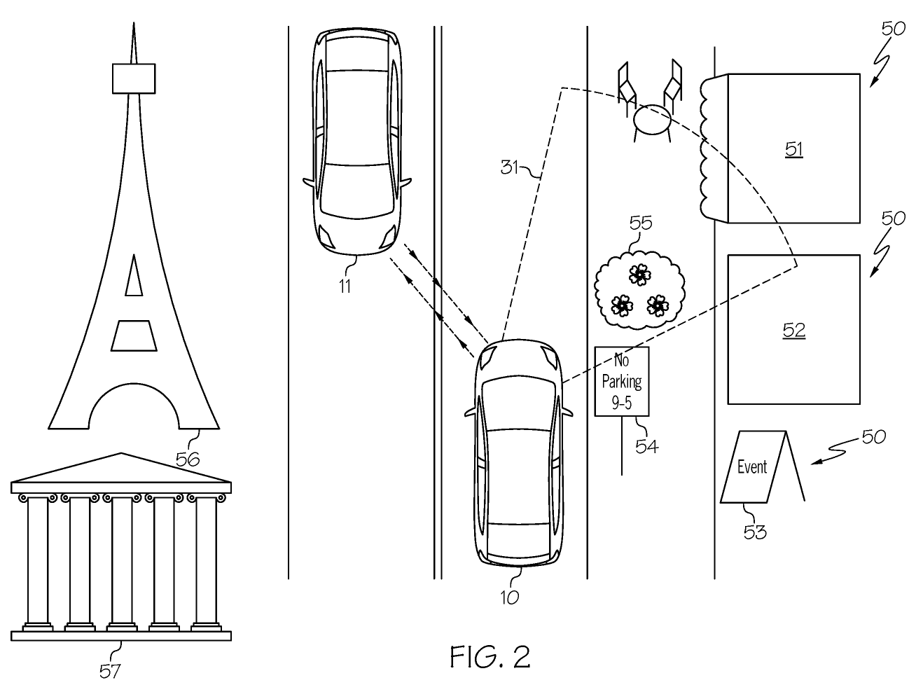

Turning now to FIG. 2, with continued reference to FIG. 1, an exemplary scenario further to the disclosures herein is shown featuring a vehicle 10 and secondary vehicle 11 driving down a busy street. A number of possible points of interest 50 may be found on this street, including a restaurant 51, an office building 52, an event sign 53, a street sign 54, flora 55, landmarks 56, and architecture 57.

As vehicle 10 travels, the one or more sensors 30 measure, evaluate, image, scan, and/or otherwise observe the environment of the vehicle 10. An exemplary field of view 31 of a sensor 30 is shown, in which the flora 55 and part of the office building 52 are visible.

As noted above, the user profile 16 may include one or more preferences 17 of one or more occupants of the vehicle 10 as they relate to features which may be identified, by way of the computational model 15, within sensor data captured by sensors 30. The one or more preferences 17 may range from broad to specific and need not explicitly dictate the manner and/or nature of features to be identified.

For example, an occupant interested in architecture may set a preference for “Roman architecture” without further detail. The computational model may then identify architecture 57 from gathered sensor data, but not landmark 56. Additionally/alternatively, the occupant may set a more specific preference, such as “Corinthian order Roman architecture,” such that the computational model 15 may search for features characteristic of the selected architectural order within the sensor data. Additionally/alternatively, the occupant may set a more abstract preference, such as “architecture with curved shapes,” whereby architecture 57 may be omitted in favor of landmark 56. These distinctions may be baked into the computational model 15 itself or may be returned as part of a query by the computational model 15 to an external server 60 or the like for forming a suitable prompt.

As another example, an occupant interested in horticulture may set a preference for “bushes,” without further detail. As above, computational model 15 may then seek to identify features within the sensor data that corresponds to objects such as flora 55. Additionally/alternatively, the preference may be for “round bushes,” or “flowering bushes,” or “privet hedges,” and so on. Accordingly, it may be appreciated that those features and/or qualities to be identified by the computational model 15 within the sensor data may be immediately apparent based on the preference set by the user (e.g., a preference for “round bushes” may clearly involve identifying round, green shapes in the sensor data that have general characteristics of plants/flora) and/or may require further processing by the computational model 15 or any supporting software/models to identify the key features to be searched (e.g., a preference for a “privet hedge” may result in the computational model 15 querying internal and/or external sources for characteristics specific to privet hedges, such as typical growth height/habits, leaf shapes, images of privet hedges, and the like, before performing object recognition).

It is further contemplated, especially in those cases of distilled models, that the “resolution” of features to be searched may also need to be adjusted. For example, while some computational models 15 may be independently sophisticated enough to search for a privet hedge, it may be necessary to also distill the features to a resolution or nature which better matches the computational model 15 being executed. So, even in an instance where the user’s preference 17 stipulates privet hedges, the computational model 15 may instead simply search more generally for a “flowering hedge.” It may be appreciated that each use case may have advantages and disadvantages depending on the situational context, and thus both are contemplated to be within the scope of the disclosures herein.

It is further contemplated that a hybrid model may be employed, such that a smaller version of the computational model 15 runs on the vehicle 10 while a larger version runs on cloud architecture, external servers 60 or edge devices, or the like.

As another example, an occupant interested in eating outdoors may set a preference for restaurants with outdoor seating. Accordingly, computational model 15 may search the sensor data for features characteristic of restaurants with outdoor seating, such as tables/chairs placed outside of an establishment with awnings/umbrellas and the like, exemplified by restaurant 51. This example underscores the benefits of the system herein over traditional techniques of, e.g., searching an online map provider for nearby restaurants. It may be the case that restaurant 51 does not typically offer outdoor seating, or does not advertise outdoor seating on its website or the map provider, such that these traditional searches would not uncover restaurant 51 as one that provides outdoor seating. But, by relying upon the sensor data collected by the sensors 30 of vehicle 10, the computational model 15 may identify that restaurant 51 currently has seats and tables outside and is thus offering outdoor seating.

Additionally, features detected by the computational model 15 may be as granular as edges, corners, textures, and/or shapes observed within the sensor data, such as the term “feature” is typically used in the computational art when referring to feature-based object recognition techniques and the like.

The user profile 16 and/or preferences 17 themselves may also include a time-related component for any notifications issued by the notifier unit 20. The occupant may configure the user profile and/or preferences 17 to log all points of interest for reporting at the end of a current trip, at the next stop, a specified duration of time from now (e.g., ten minutes from now, one hour from now), a specified duration of time from when the feature was identified (e.g., thirty seconds after detection, one hour from detection), or even immediately (e.g., notify me immediately when you detect a restaurant with outdoor seating).

Feature detection performed by the computational model 15 may also include the contents of signage, such as event signs 53 or street signs 54, which may indicate characteristics such as event details, promotional details (e.g., store sales), and the like.

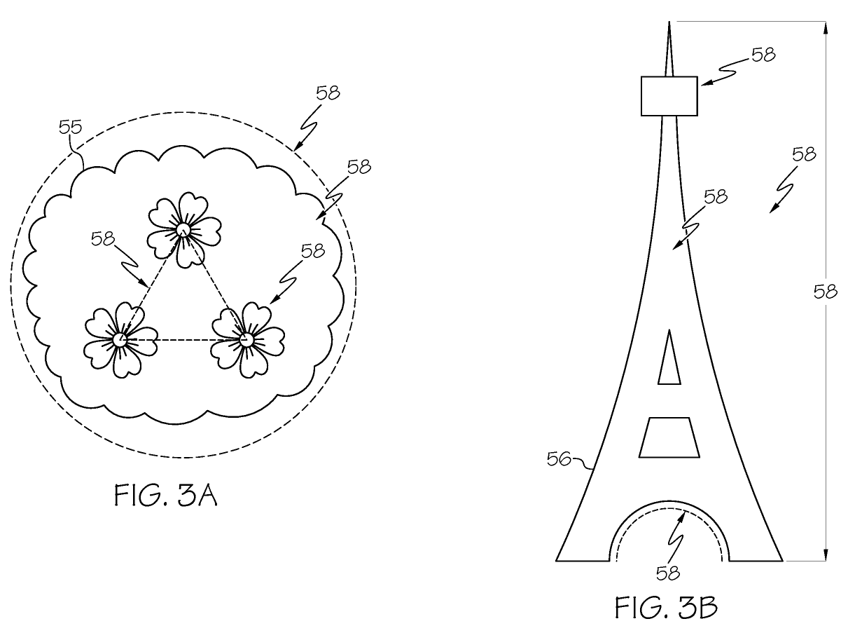

Turning now to FIGS. 3A-B, flora 55 and landmark 56 are shown in greater detail to illustrate the various features 58 which may be detectable by computational model 15 when performing feature recognition. Features 58 of flora 55 may be that flora 55 is a bush, or that flora 55 is a round bush, or that flora 55 is a bush with flowers, or that flora 55 is a bush with flowers in a certain pattern and/or spaced a certain distance apart, or that flora 55 has a certain diameter, and the like. Similarly, features 58 of landmark 56 may be that landmark 56 has a certain height, or that landmark 56 has curves in its architecture, or that landmark 56 has a certain silhouette, or that landmark 56 has a certain architectural style, or that landmark 56 has an observational deck, and so on.

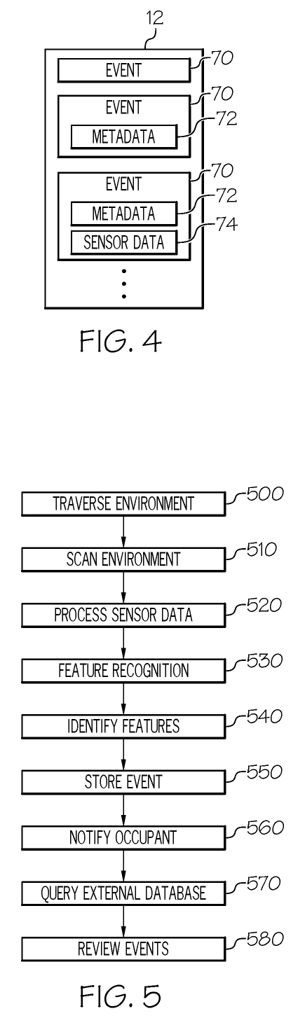

Turning now to FIG. 4, conceptualizations of data structures, or events 70, are schematically shown stored in storage units 12. As discussed above, once features are identified by the computational model 15 within the sensor data, these detections may then be stored for later perusal by the occupant. In some advantageous embodiments, these detections may be stored as discrete events 70 which contain information relating to the detection. Each event 70 may contain any combination of metadata 72 and sensor data 74 relating to the detection/identification of the feature. Examples of metadata 72 may include the time at which the sensor data was collected whereby one or more features corresponding to the occupant’s preferences 17 was detected or identified by the computational model 15, a location of the vehicle at the time of detection/identification, a description of the feature and/or preference so identified, information obtained pursuant to the detection (e.g., a menu of a restaurant that was identified, an article describing the type of hedge that was identified, a program for a show being performed whose advertisement/signage was detected), descriptions of the feature (e.g., human-readable summaries of those features or elements which were detected in the sensor data and/or which gave rise to a positive identification of the feature), and the like, without limitation. The sensor data 74 so stored may be the complete sensor data relating to the detection/identification event 70 and/or a subset thereof. Storing each detection/identification event 70 in this manner makes it easier for the occupant to then go back and review those feature identifications which occurred during a trip, ensuring that more of the trip and/or surroundings which were traversed and that are relevant to the occupant are brought to the occupant’s attention.

Additionally, details, lists, descriptions, and/or other data relating to events 70, as well as the events 70 themselves, may be included (e.g., as a link, attachment, embed, or the like) in any notifications which are sent to the occupant as a result of the detection/identification of features within the sensor data.

Turning now to FIG. 5, in reference to FIGS. 1 and 4, a flow chart describing a detection process is shown.

In step 500, the vehicle 10 traverses an environment, such as a road, street, highway, dirt path, off-roading path/trail, and the like, without limitation.

While traversing the environment, in step 510, one or more sensors 30 provided on the vehicle 10 measure, scan, evaluate, observe, map, and/or otherwise collect sensor data describing the environment which the vehicle 10 is traversing.

In step 520, any intermediate processing which is necessary to convert the readings taken by the one or more sensors 30 is performed to place the readings of the sensors 30 in a format which is readable, parse-able, or otherwise usable by the computational model 15.

In step 530, the computational model 15 performs feature recognition on the raw sensor data collected in step 510 and/or the processed sensor data generated in step 520 based on those preferences 17 which are stored within the user profile 16.

In step 540, one or more features which correspond to one or more preferences 17 are identified by the computational model and set aside for further processing.

In step 550, optionally, the system stores the feature identified in step 540 as an event 70, which may include metadata 72 and/or sensor data 74 relating to the feature identification. This event may be sent to the occupant immediately and/or retained for later perusal by the occupant, such as upon completion of a trip or during a stop.

In step 560, optionally, the system notifies the occupant of the feature identification by way of the notifier unit 20. Notifier unit 20 may notify the occupant by way of a visual notification (e.g., blinking lights, text/email messaging, and the like), audio notification (e.g., alert sound, pre-recorded message, real-time synthesized message), haptic notification (e.g., vibrating a steering wheel 28a and/or seat 28b of the vehicle 10), or other suitable means of notification by which the feature identification may be brought to the occupant’s attention.

Notifications may be tailored based upon prevailing contexts. For instance, depending on the attention span, current emotional state, current workload, or the like of the occupant, the system may notify the occupant of the identified feature sooner or later than otherwise scheduled. Likewise, depending on the driving conditions (e.g., rain or other inclement weather, heavy traffic, and the like), the system may notify the occupant of the identified sooner or later than otherwise scheduled. These contexts may be identified by the computational model 15 or another model suited to such a determination, which may leverage any of the sensors 30 that are observing the environment of the vehicle 10 as well as internal sensors which may be observing the occupant specifically (e.g., driver monitoring cameras).

In step 570, optionally, the system may query one or more external databases 62 for supplemental information relating to the detected feature which, in turn, may be stored with the event 70 of step 550 or included as part of the notification of step 560.

Finally, in step 580, optionally, the occupant may query any events 70 which are stored in any storage units 12 to inform themselves regarding any features, landmarks, points of interest, or the like which were detected by the vehicle during the trip.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for detecting points of interest, the system comprising:
a vehicle, wherein the vehicle comprises at least one processor and at least one sensor, and the at least one sensor is configured to measure an environment of the vehicle;
a computational model executed by the at least one processor, wherein the computational model is configured to perform feature recognition on sensor data obtained by the at least one sensor; and
a user profile, wherein the user profile is configured to store at least one preference of an occupant of the vehicle, the at least one preference relating to features which are identifiable by the computational model.

2. The system according to claim 1, further comprising a notifier unit, wherein the notifier unit is configured to provide at least one of an auditory notification, a visual notification, and a haptic notification to the occupant that the computational model has identified at least one feature within the sensor data which corresponds to one or more of the at least one preference.

3. The system according to claim 2, wherein the auditory notification is sound played through a speaker.

4. The system according to claim 2, wherein the visual notification is a display of at least one of an image, a text, a user interface element, and a light.

5. The system according to claim 2, wherein the haptic notification is a mechanical actuation of at least one of a seat and a steering wheel of the vehicle.

6. The system according to claim 1, further comprising a storage unit,
wherein the storage unit is configured to, when the computational model has identified at least one feature within the sensor data which corresponds to one or more of the at least one preference, store an event which relates to identification of the at least one feature.

7. The system according to claim 6, wherein the event comprises at least one of metadata relating to the identification of the at least one feature and the sensor data in which the at least one feature was identified.

8. The system according to claim 7, wherein the metadata comprises at least one of:
a time corresponding to when the sensor data was collected in which the at least one feature was identified;
a location of the vehicle corresponding to where the sensor data was collected in which the at least one feature was identified;
a location of the at least one feature so identified; and
a description of the at least one feature so identified.

9. The system according to claim 6, wherein the storage unit is configured to retain one or more events for review by the occupant after the identification of the at least one feature by the computational model.

10. The system according to claim 9, wherein the one or more events are retained for review by the occupant after completion of a trip during which the at least one feature was identified.

11. The system according to claim 1, wherein the vehicle further comprises a network interface and is configured to query an external database for information relating to a feature identified by the computational model.

12. A method for detecting points of interest, comprising:
providing a vehicle comprising at least one processor and at least one sensor, wherein the at least one sensor is configured to measure an environment of the vehicle;
measuring the environment using the at least one sensor to generate sensor data;
processing the sensor data using a computational model executed by the at least one processor, wherein the computational model is configured to perform feature recognition on the sensor data; and
identifying at least one feature within the sensor data which relates to at least one preference of an occupant of the vehicle, wherein the at least one preference is stored within a user profile.

13. The method according to claim 12, further comprising:
notifying the occupant that the at least one feature was identified within the sensor data, wherein said notification occurs via at least one of an auditory notification, a visual notification, and a haptic notification.

14. The method according to claim 12, further comprising:
storing, for later review by the occupant, an event relating to the identification of the at least one feature, wherein the event comprises at least one of metadata relating to the identification of the at least one feature and the sensor data in which the at least one feature was identified.

15. The method according to claim 14, wherein the event is retained for review by the occupant after completion of a trip during which the at least one feature was identified.

16. The method according to claim 14, wherein the metadata comprises at least one of:
a time corresponding to when the sensor data was collected in which the at least one feature was identified;
a location of the vehicle corresponding to where the sensor data was collected in which the at least one feature was identified;
a location of the at least one feature so identified; and
a description of the at least one feature so identified.

17. The method according to claim 12, further comprising:
querying an external database for information relating to the at least one feature identified by the computational model.

18. A vehicle, comprising:
at least one processor;
at least one sensor;
a non-transitory computer-readable storage medium containing instructions that, when executed by the at least one processor, causes the at least one processor to execute a computer model; and
a user profile,
wherein the user profile is configured to store at least one preference of an occupant of the vehicle, the at least one preference relating to features which are identifiable by the computational model, and
wherein the computational model is configured to be executed by the processor to perform feature recognition on sensor data describing an environment of the vehicle obtained by the at least one sensor to identify at least one feature which corresponds to the at least one preference.

19. The vehicle according to claim 18, further comprising:
a notifier unit, wherein the notifier unit is configured to provide at least one of an auditory notification, a visual notification, and a haptic notification to the occupant that the computational model has identified at least one feature within the sensor data which corresponds to one or more of the at least one preference.

20. The vehicle according to claim 18, further comprising:
a storage unit, wherein the storage unit is configured to, when the computational model has identified at least one feature within the sensor data which corresponds to one or more of the at least one preference, store an event which relates to identification of the at least one feature.
